(19) United States
(12) Patent Application Publication
(10) Pub. No.: US 2001/0039541 A1
(43) Pub. Date: Nov. 8, 2001

(54) Information retrieval system on internet

(75) Inventors: Kiyotaka Okawa, Osaka-shi (JP); Toru Terada, Osaka-shi (JP)

Correspondence Address: Merchant, Gould, Smith, Edell,, Welter & Schmidt, 3100 Norwest Center, 90 South Seventh Street, Minneapolis, MN, 55402-4131, US

(73) Assignee: Digital Soken Inc.

(21) Appl. No.: 09/812,542

(22) Filed: Mar. 20, 2001

(30) Foreign Application Priority Data
Mar. 22, 2000 (JP) 2000-080234

(51) Int. Cl. G06F 15/16; G06F 17/30

(52) U.S. Cl. 707/3; 709/219

(57) ABSTRACT

A system which allows a plurality of unspecific retrievers under various environments of computers to retrieve updated information. The system includes a WEB server and a client connected to the WEB server via Internet. The WEB server includes figure data storage device for storing whole figure information including a retrieval object, parts information storage device for storing parts information upon parts including the retrieval object, figure information storage device for storing figure information including coordinate data upon the figure data, and information two-way link device for linking parts information with figure information mutually. The client includes a general-purpose WEB browser on which the parts information and the figure information are display simultaneously.

### BACKGROUND OF THE INVENTION

### FIELD OF THE INVENTION

The present invention relates to an information retrieval system which allows a retriever, or a user, employing a client (i.e. a client in a client/server architecture, the client including a personal computer), to have access to information upon a retrieval object stored on a server (or on a server side), via the Internet. In other words, the present invention relates to the information retrieval system on the Internet, by which the retriever can get the information thereupon stored on the server, on a side of the client. More particularly, the invention relates to the information retrieval system, in which a plurality of unspecific retrievers under various environments of computers can get the information thereupon via the Internet by selecting one of a whole figure display file including the retrieval object and a partial information file of the retrieval object where the whole figure display file and the partial information file are linked to each other bidirectionally.

Incidentally, the terminology of the “whole”, and that of the “partial”, are used herein in relation of inclusion (i.e. relation of “including” and “being included”) meaning that the “whole” includes the “partial” constituting a part of the “whole”; for example, they are used herein in relation of inclusion meaning that a “product” includes a “component” constituting a part of the “product”, or that a “map” designates a “building” thereon constituting one of elements designated on the “map”, or the like.

### DESCRIPTION OF THE RELATED ARTS

Conventionally, there have been known various types of retrieval methods. FIG. 1 shows an example employing a sheet of printed paper (or printed material) on which a whole figure display file (corresponding to “—page 2—” in the figure) of a product (a pencil), and a list of parts information (corresponding to “—page 3—” in the figure), are printed. For simplifying the explanation thereof, a detailed description will be made upon a particular case: the “whole” (i.e. a product) is a pencil, and a retrieval object (i.e. a part or a component) is an eraser of the pencil.

For example, when a retriever, who is a general customer, wants to buy a new eraser at a retail shop in order to replace a consumed eraser of the pencil therewith, the retriever firstly needs to specify a product name of the pencil and a product number of the eraser, because there are various kinds of erasers of pencils.

Then, the retriever makes an inquiry about what the product name of the pencil with the eraser is, to a retailer at the shop. Then, if the retailer does not know the product name thereof, he/she has to make an inquiry thereabout to a manufacturer (or maker) of the pencil in turn. Based upon the information from the retailer, the manufacturer retrieves paper figures and paper lists kept in a storehouse storing various paper figures and paper lists, in order to specify the pencil and the product name thereof. Then, if the paper figure(s) and the paper list(s) corresponding to the pencil are found out by the retrieval, the manufacturer collates, or compares, the information upon the paper figure(s) and paper list(s) with the information upon the eraser inquired by the retailer. Then, if the former information is coincident with the latter information, any detailed information upon the eraser is fed back to the retriever via the retailer.

As apparent from the aforementioned explanation, the method of retrieval employing the printed paper (or printed material) as shown in FIG. 1, for example, has the problems of:

(1) requiring much work and long time for the retrieval;

(2) requiring space for storing such paper figures and paper lists;

(3) requiring to make the retriever wait until any necessary retrieval information is gotten;

(4) aging, or deterioration, of paper which makes it difficult to make out, or decipher, the information written and/or printed thereupon; and/or

(5) causing the retriever to make any mistake in his/her retrieval, with a relatively high possibility.

On the other hand, as a retrieval method which does not employ such paper materials, there has conventionally been known a retrieval method employing a computer storage medium (or a recording medium for computer), such as a floppy disc, CD-ROM, or DVD, which stores a whole figure including a retrieval object and stores any detailed information upon the retrieval object.

In order to carry out this type of retrieval method, firstly, an information provider (a manufacturer of a pencil, for example) needs to prepare and make a computer storage medium for storing data, including information upon the whole figure (a pencil including an eraser, for example) and information upon each component, or part, of the pencil (the eraser, a wooden part, and a cap, for example), in which the former information and the latter information are linked to each other bidirectionally.

Meanwhile, the retriever needs in advance to install a particular software exclusively employed for retrieving parts, or components, into his/her own computer for the purpose of viewing the information stored on the computer storage medium, and he/she also needs in advance to obtain the computer storage medium from the information provider. Under this situation, when the retriever actuates his/her computer terminal with both of the software and the computer storage medium being installed therein, both of the whole figure of a pencil including an eraser and a list of parts information thereof are displayed as shown in FIG. 2. Looking at the image display (or screen display) of the computer terminal, the retriever clicks on a point, or part, of one of a figure display section displaying the whole figure and a parts information display section displaying the list of parts information (for example, clicks on the “eraser” displayed on the figure display section). This clicking operation makes the other (for example, the “eraser” displayed on the parts information display section) of the figure display section and the parts information display section be displayed to designate detailed information upon the “eraser”. In this way, the retriever can get various detailed pieces of information upon a retrieval object (for instance, the “eraser” of the pencil in the above example), on the computer terminal.

In the aforementioned retrieval method employing the computer storage medium (or computer storage media), the information upon the figure of a retrieval object and the information upon the parts thereof are mutually linked. However, the method of retrieval employing the computer storage medium, for example, has the problems of:

(1) requiring various types of software, exclusively employed for retrieving parts or components, corresponding to various Operating Systems (such as WINDOWS, MAC, UNIX, or LINUX) the retrievers use;

(2) allowing a particular type of software not to be employed in other environments of Operating Systems of computers except for the very particular environment thereof which has been introduced to the particular computer terminal (namely, allowing the particular type of software to be employed only in a closed environment of computer);

(3) having to prepare, make and transfer the computer storage medium (computer storage media) storing updated information every time the information (for example, information upon price) is updated; and

(4) allowing only a particular retriever, to whom the computer storage medium is transferred, to retrieve the retrieval object (namely, allowing any retriever who does not have the computer storage medium not to retrieve the retrieval object).

As apparent from the aforementioned explanation, the conventional retrieval system employing the computer storage medium (or media) has a drawback, or disadvantage, which does not allow a plurality of unspecific retrievers under various environments of computers to get easy access to the newest information.

### SUMMARY OF THE INVENTION

Accordingly, it is an object of the present invention to provide an information retrieval system which allows a plurality of unspecific retrievers, or users, under various environments of computers, to easily get the newest information.

In accomplishing this and other objects of the present invention, there is provided an information retrieval system on internet, the information retrieval system including a web server and a client which is connected to the web server via the internet, in which the web server and the client have a two-way communication with each other, the web server comprising: figure data storage means for storing figure data on a whole including an object of retrieval and for transmitting the figure data to the client in response to an instruction from the client; parts information storage means for storing parts information upon objects constituting the whole in which each of the objects is the object of retrieval and in which the parts information is written in mark-up language that is able to define an optional tag, and for transmitting the parts information to the client in response to an instruction from the client; figure information storage means for storing figure information including coordinate data with respect to the figure data in which the figure information is written in mark-up language that is able to define an optional tag, and for transmitting the figure information to the client in response to an instruction from the client; and information link means for linking the parts information and the figure information to each other bidirectionally, and the client comprising: a general-purpose web browser for showing the parts information and the figure data simultaneously, in which the parts information and the figure data are linked to each other bidirectionally.

According to the mechanism, when the retriever, or user, boots the general-purpose web browser (or WEB browser) of the client which is connected to the internet (or Internet) and then he/she inputs an address (URL) of the web server (or WEB server) on which both of the figure data on a whole including an object of retrieval (or a retrieval object or a target retrieval object) and parts information upon the objects of retrieval are stored, the client is accessed to the server corresponding to the address (URC). As a result, both of the figure data on the whole including the object of retrieval and detailed parts information upon the objects constituting the whole, are transmitted from the web server to the client.

On a display screen of the client, a whole figure (or a total figure) including the object of retrieval, and a parts information group in which the objects (i.e. various parts or components), including the object of retrieval, are displayed. From the whole figure, the coordinate data relative to the objects (or parts or components) on the figure are extracted by an automatic reading software or by a manual reading; and the objects of retrieval which are shown on the whole figure and the objects of retrieval which are shown on the parts information group, are linked to each other bidirectionally, by the mark-up language which is defined by an optional tag.

With the mechanism, therefore, the retriever, or user, who uses the general-purpose web browser on the internet, can retrieve any desired object of retrieval from the whole figure or from the parts information group. That is, when the retriever clicks a desired object of retrieval on one of the whole figure and the parts information group (for example, when the retriever clicks a desired object of retrieval on the whole figure) while watching on the display screen of the general-purpose web browser, it is jumped to an address of the other thereof (for example, detailed parts information) which is linked to the one so that detailed information thereupon (for example, its name of component, its color, its price, its material, etc.) is displayed. Accordingly, a plurality of unspecific retrievers, or users, under various environments of computers, can get the detailed information easily.

Meanwhile, when the information upon the object(s) of retrieval becomes old, or outdated, an information provider can update, or renew, the information stored, or recorded, on the web server. Namely, the information thereupon can be changed into the newest information promptly.

Consequently, a plurality of unspecific retrievers, or users, under various environments of computers, can get the detailed and newest information upon the object(s) (or part(s) or component(s)) of retrieval on the clients, easily and speedily.

Although there have been known HTML (i.e. Hypertext Mark-up Language) or SGML (Standard Generalized Mark-up Language) as the mark-up language, it is preferable to employ XML (Extensible Mark-up Language).

The HTML is a language which is mainly employed for making a home page that is the image firstly displayed, when the web server is accessed by a client able to make use of the internet. This language is the language in which document(s) and/or image(s) are put together, built up, or assembled, structurally by a type of command called a tag. However, the tag employed for the HTML is the tag which can be employed only for a particular browser. Therefore, the HTML has a problem that it is not possible to exchange data between different web browsers.

In contrast, the XML is the mark-up language made for use on the internet by removing too much complicated parts from the SGML, or by removing parts not employed so often therefrom. Namely, the XML is a simplified version of the SGML.

In addition, the XML has an extendability which allows a user, or an information provider, to optionally or originally define information upon attributes of data by using an optional tag (or original tag), and to describe it by correlating the attributes of the data and the contents of the data with each other. The data contents described by the XML can be shown and read on free web browsers which are distributed by Microsoft Corporation and Netscape Communication Corporation. Consequently, it is possible to exchange data between systems with different OS (Operating System) on the internet. In other words, the retriever, or user, who retrieves any necessary information upon an object, or objects, on the internet, can retrieve it by employing the free general-purpose web browser without introducing an exclusive software for retrieving the information thereupon.

In the mechanism, it is preferable that the figure data are image data which do not have attribute of coordinates.

Namely, as the figure data, it is possible to employ various types of image data. However, taking the communication speed and/or actual utility (or applicability or feasibility) on the internet into consideration, it is preferable to employ a format (or type) of the image data which has a relatively high efficiency of compression and which does not have attribute of coordinate information. At present, as such a format (or type) of the image data, GIF format or JPEG format, which is a standard format thereof on the internet, can be employed.

In the mechanism, it is preferable that when a retriever selects one of the objects of retrieval which are shown on the general-purpose web browser, the one thereof changes visually on the general-purpose web browser.

According to the mechanism, the one of the objects is shown on the general-purpose web browser with the one thereof being visually highlighted (or emphasized or stressed). Therefore, for example, even if the target object the retriever, or user, tries to find out for the retrieval on the display screen is shown amongst many other objects (or parts or components) on the whole figure thereon, he/she can easily find out the target object visually.

In the mechanism, it is preferable that there is further provided an external output means for allowing a retriever to take out a result of the retrieval and to make use of the result.

According to the mechanism, any result of the retrieval shown on the general-purpose web browser can be taken out by the external output means such as an electromagnetic recording medium (for example, a hard disk or a floppy disk), a printing means (for example, a printer), or the like. Namely, any result of the retrieval can be stored on the external output means, or outputted to the external output means. In other words, the retriever can retrieve the object(s) of retrieval offline with respect to the internet. Therefore, with the mechanism, the reduction of cost for communications on the internet can be realized.

### BRIEF DESCRIPTION OF THE DRAWINGS

This and other objects and features of the present invention will become clear from the following description taken in conjunction with the preferred embodiment thereof with reference to the accompanying drawings, in which:

FIG. 1 is an explanatory view showing a conventional retrieval method of how to retrieve information upon a retrieval object by means of printed paper material (or printed matter);

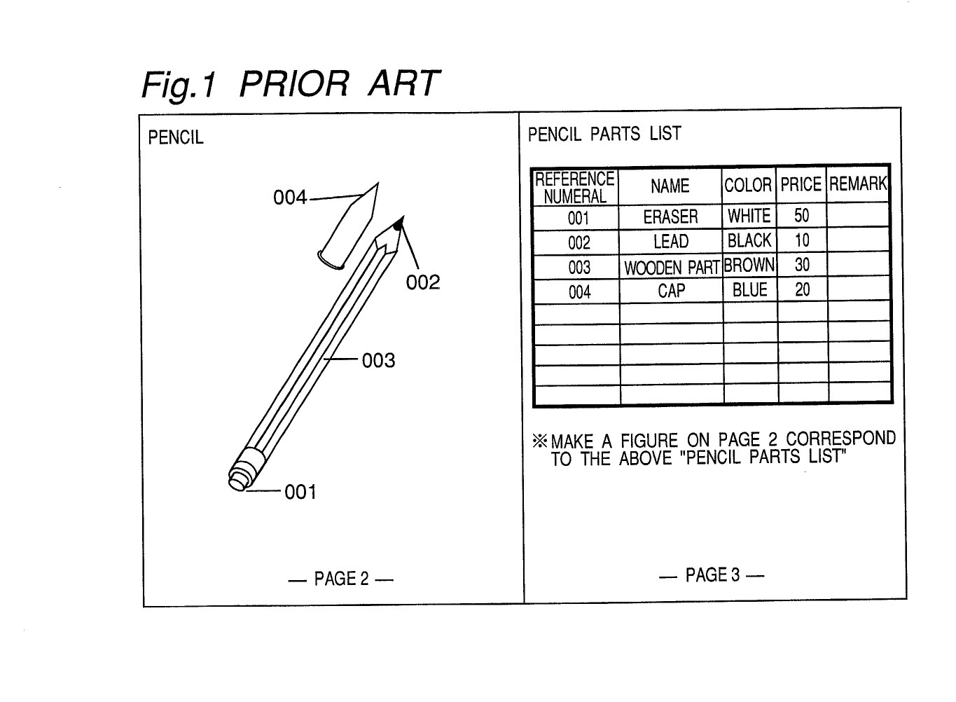

FIG. 2 is an explanatory view showing a conventional retrieval method of how to retrieve information stored, or recorded, on a computer recording medium (or computer storage medium) by means of a software which is exclusively employed for retrieving objects or parts;

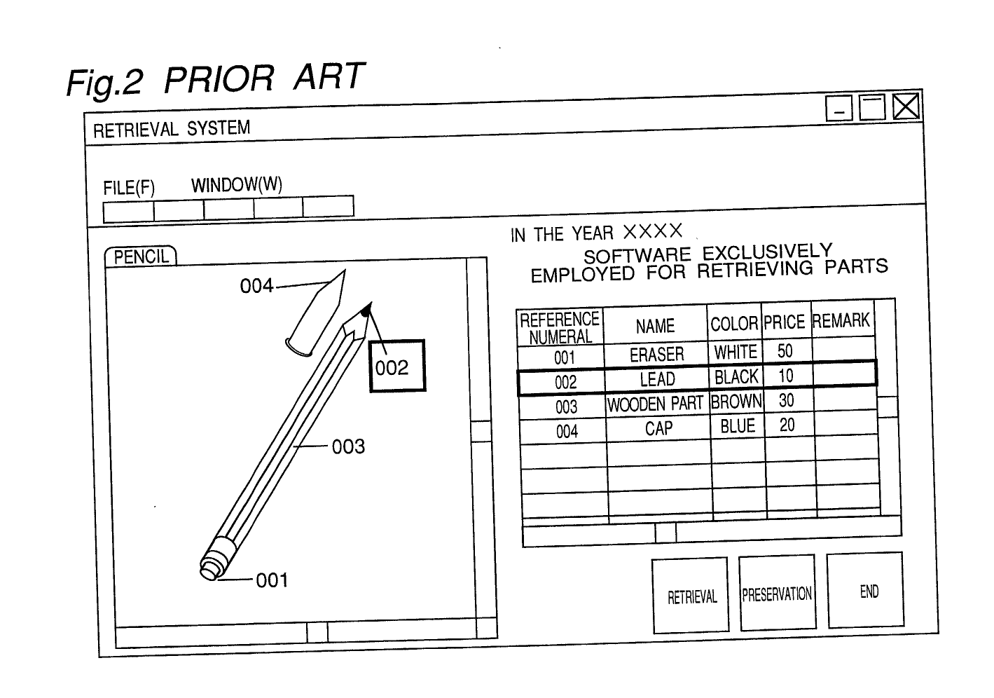

FIG. 3 is a block diagram showing an overall structure of an information retrieval system according to a preferred embodiment of the present invention;

FIG. 4 is a view of a display screen shown on a WEB browser, under a situation in which a user retrieves a particular piece of information by using the information retrieval system of FIG. 3;

FIG. 5 is a flow chart showing a procedure for making electronic data upon retrieval objects in the information retrieval system of FIG. 3;

FIG. 6 is a flow chart showing a series of steps up to a step at which the retrieval information is displayed on the WEB browser in the information retrieval system of FIG. 3;

FIG. 7 is a flow chart showing a series of steps, for retrieving the retrieval objects, following the procedure shown in FIG. 6;

FIG. 8 is a flow chart showing a series of steps, for retrieving the retrieval objects, following the procedure shown in FIG. 7;

FIG. 9 (consisting of FIGS. 9A, 9B and 9C) is an explanatory view showing a procedure of operation on the WEB browser at time of executing the procedure shown in FIGS. 7 and 8, where

FIG. 9B is the explanatory view showing the procedure of operation for retrieving the retrieval objects from a parts information display section displayed on the WEB browser, and

FIG. 9C is the explanatory view showing the procedure of operation for retrieving the retrieval objects from a figure display section displayed thereon;

FIG. 10 is an explanatory view showing an XML file in which the parts information display section displayed on the WEB browser shown in FIG. 4 and the figure display section displayed thereon are linked to each other bidirectionally;

FIG. 11 is an explanatory view showing detailed information included in the parts information display section shown in FIG. 10; and

FIG. 12 is an explanatory view showing detailed information included in the figure display section shown in FIG. 10.

### DETAILED DESCRIPTION OF THE PREFERRED EMBODIMENT

Before a description of a preferred embodiment of the present invention proceeds, it is to be noted that like or corresponding parts are designated by like reference numerals throughout the accompanying drawings.

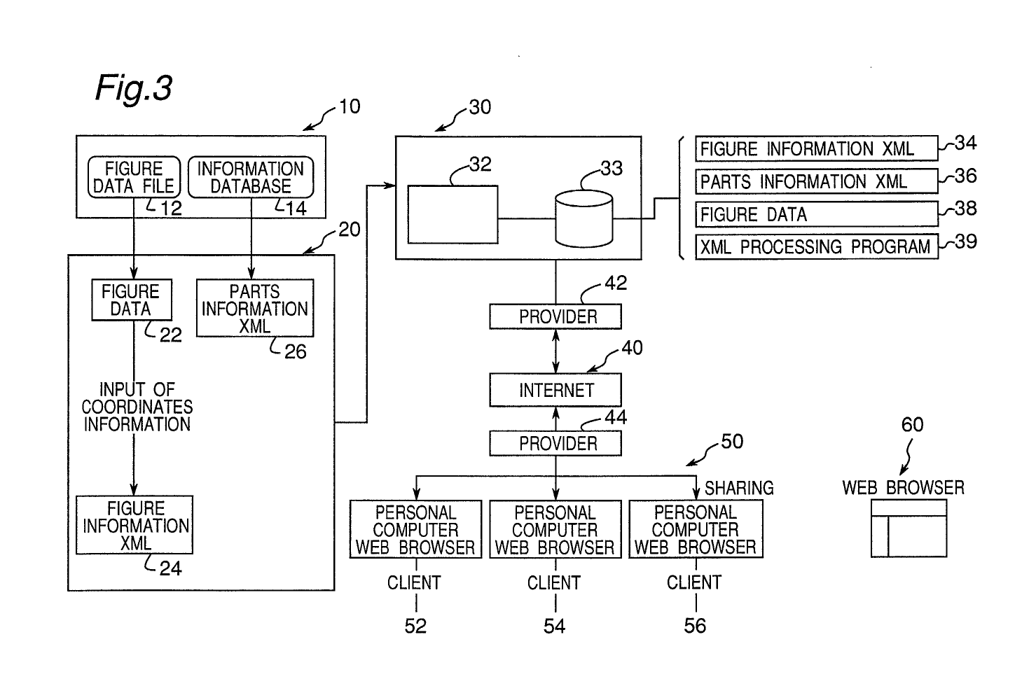

Referring to FIGS. 3 through 12, the description is made below in detail upon an information retrieval system according to the preferred embodiment thereof.

FIG. 3 is a block diagram showing a general structure of an information retrieval system. As shown in the diagram, the information retrieval system has a database 10 which stores original information provided by an information provider, a WEB registration information making means (or WEB record information making means) 20, a WEB server 30 which stores any desired information or data, an Internet 40, and a plurality of clients (i.e. clients in a client/server architecture, each of the clients including a personal computer) 52, 54, 56 employed by common users (or general customers) who are retrievers. The WEB server 30 is connected to the Internet 40 through a provider 42 via telephone lines. The clients 52, 54, 56 are also connected to the Internet 40 through a provider 44 via telephone lines.

With the arrangement, the WEB server 30 and the clients 52, 54, 56 can exchange data bidirectionally, therebetween.

By the way, alternatively, the database 10 and the WEB registration information making means 20 may be provided in another system rather than the information retrieval system of the preferred embodiment.

The database 10 includes figure information 12 (for example, a figure of a pencil, as described later) on any retrieval object which is directly supplied by the information provider (for example, by a pencil manufacturer), and includes parts information (or components information) 14 (for example, information upon an eraser, a lead, a cap, and the like, of a pencil, as described later) which is also directly supplied by the information provider. The figure information 12 is in a form of electric image data, etc., formed by an electric camera, corresponding to the figure printed on paper provided by the information provider. Similarly, the parts information 14 is in a form of electric parts information data, etc., formed in accordance with the information provider's original electric format, corresponding to the parts information printed on paper provided by the information provider.

Based upon the figure information 12 and the parts information 14 provided by the information provider, the WEB registration information making means 20 edits and processes figure data 22 for WEB (or WEB figure data 22) that are electronic data usable on the Internet as a GIF file or a JPGE file, and it edits and processes a parts information XML file 26 in a text format that is also electronic data usable thereon as the file.

Then, coordinate data on a part (or component), or parts (or components), shown in the figure data 22 for WEB, are extracted by the aid of an automatic reading software or by a manual reading. Then, a figure information XML file 24 which links the coordinate data of the figure data 22 for WEB and the parts information of the parts information XML file 26 to each other bidirectionally is made.

Then, the figure data 22 for WEB, the figure information XML file 24, and the parts information XML file 26, which have been made as electronic data usable on a WEB browser 60, are registered, or stored, on the WEB server 30.

Under the arrangement, when the information becomes old, or out-of-date, the information provider, or a supervisor of the WEB server 30, can promptly update the information by changing the information stored on the WEB server 30.

The XML (Extensible Mark-up language) file is a file which is specialized for the use of the Internet by removing too much complicated programs of the SGML, or by removing rarely used programs thereof. That is, the XML file is a file which is prepared and made as a simplified version of the SGML.

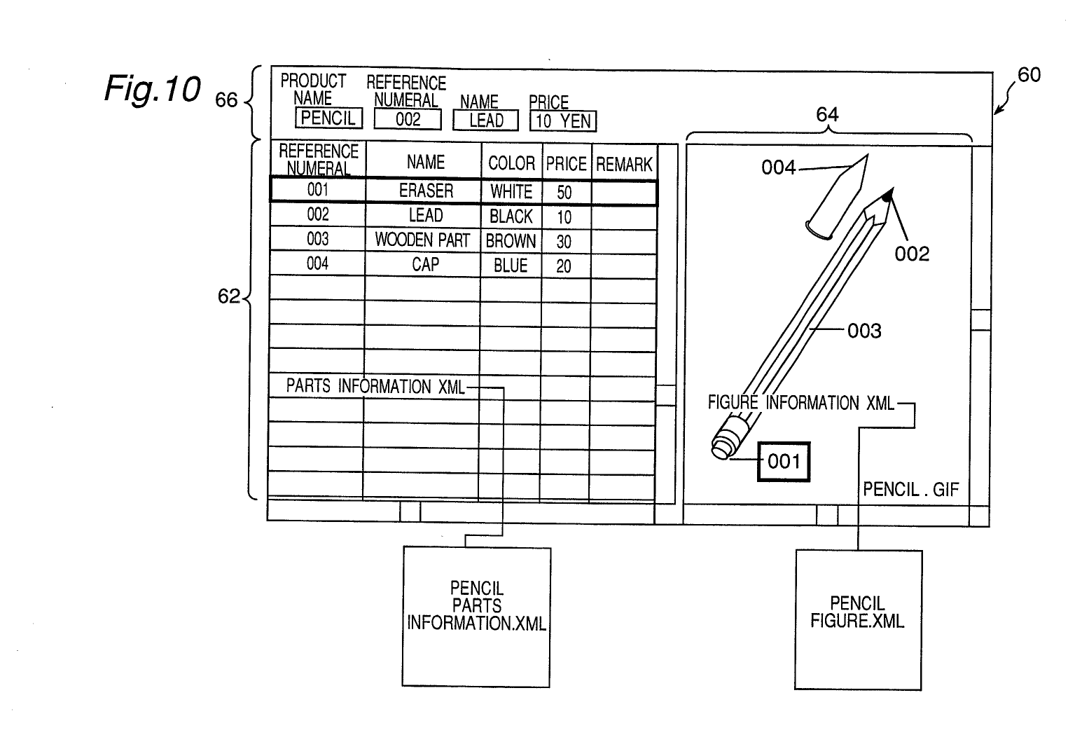

As shown in FIGS. 10 through 12, the XML file also has an extendability which allows the retriever to define information upon data attributes (for example, a whole name, a reference numeral, a figure number, a part name (or component name), a price, etc.) by using original tag(s), and which allows the retriever to edit information in a text style by correlating the data attributes and the data contents with each other. The data/information stored on the XML file can be displayed and browsed by the general-purpose WEB browser distributed free by Microsoft Corporation and Netscape Communications Corporation. That is, the contents made by the XML file can be edited by a text editor, and the data can be exchanged on the Internet between different computer systems with different OS (i.e. Operating System).

The WEB server 30 has an information processing means 32, such as a CPU, which performs processing, controlling each section thereof, and controlling input/output of data; the WEB server 30 also has an electromagnetic storage means (or electromagnetic recording means) 33, such as a hard disk; and the WEB server 30 employs an OS such as a UNIX WORKSTATION, a WINDOWS NT, or the like. On the hard disk 33, there are stored a figure information XML file 34(24), a parts information XML file 36(26), and figure data 38(22) for WEB. Also, on the hard disk 33, there is also stored an XML processing program 39 as information linking means (or information link means) such as XSL, JAVASCRIPT, and CGI. The XML processing program 39 is programmed so as to establish a two-way linkage (or a bidirectional linkage) between the figure information XML file 34 and the parts information XML file 36. The figure information XML file 34 stored on the hard disk (i.e. electromagnetic storage means) 33 forms a figure information storage means; the parts information XML file 36 forms a parts information storage means; and the figure data 38 for WEB forms a figure data storage means. These files 34, 36 and data 38 are not necessarily stored on the hard disk 33 of the same WEB server 30. Namely, alternatively, these files 34, 36 and data 38 may be stored on the hard disk(s) of different WEB server(s).

Each of the clients 52, 54, 56 has an information processing means, such as a CPU, which performs processing, controlling each section thereof, and controlling input/output of data, has an electromagnetic storage means such as a hard disk, has a display means such as a CRT (Cathode Ray Tube) display and an LCD (Liquid Crystal Display), and has an external output means such as a printer. The clients 52, 54, 56 have different Operating System (OS) such as WINDOWS 95, 98 and 2000.

On the hard disk 33, there are stored any necessary various processing programs which display the general-purpose WEB browsers 60 such as Internet Explorer and Netscape Navigator.

This arrangement allows a multitude of unspecific retrievers under various environments of computers with different OS to have access to the WEB server 30, in order to retrieve any necessary information via of the general-purpose WEB browsers 60.

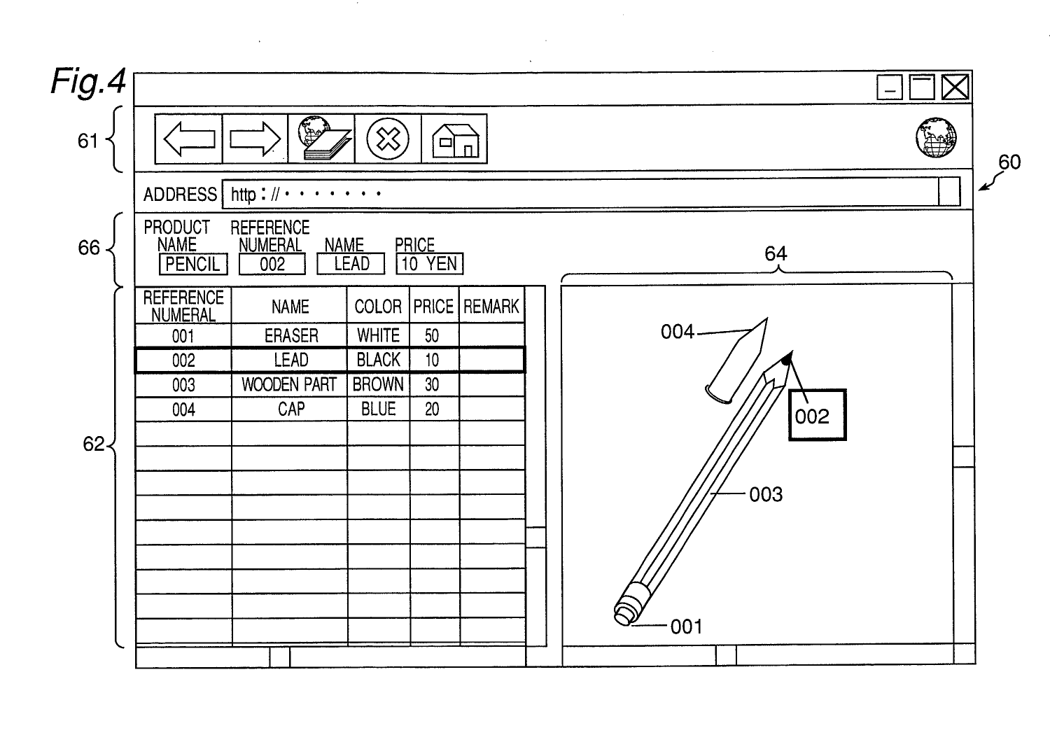

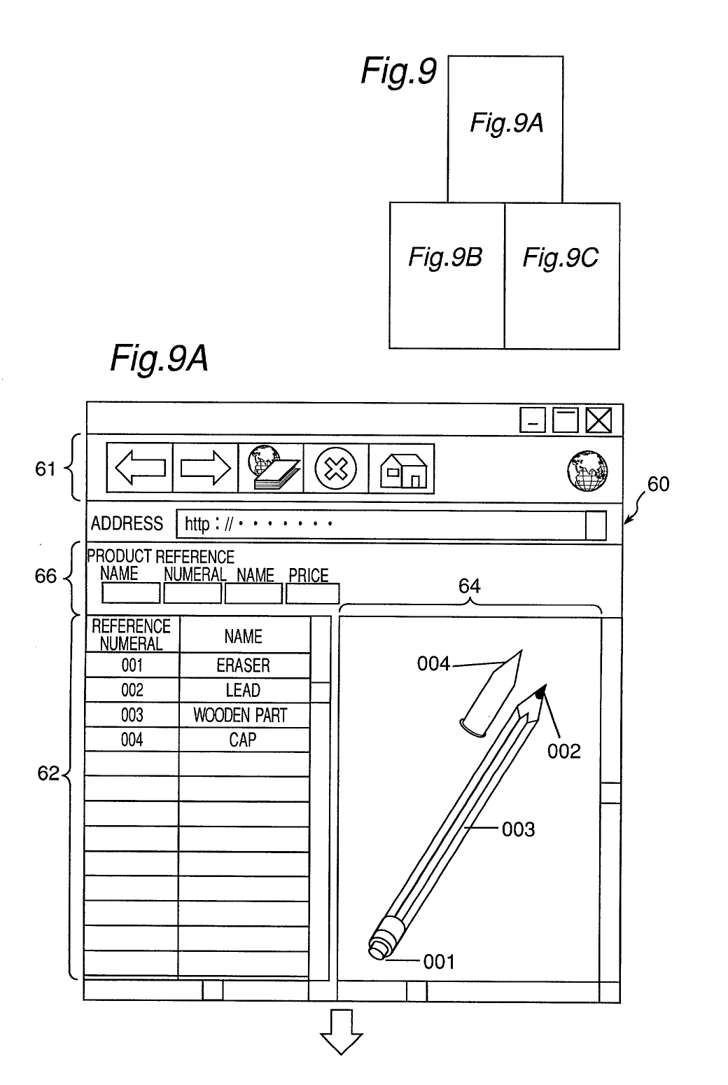

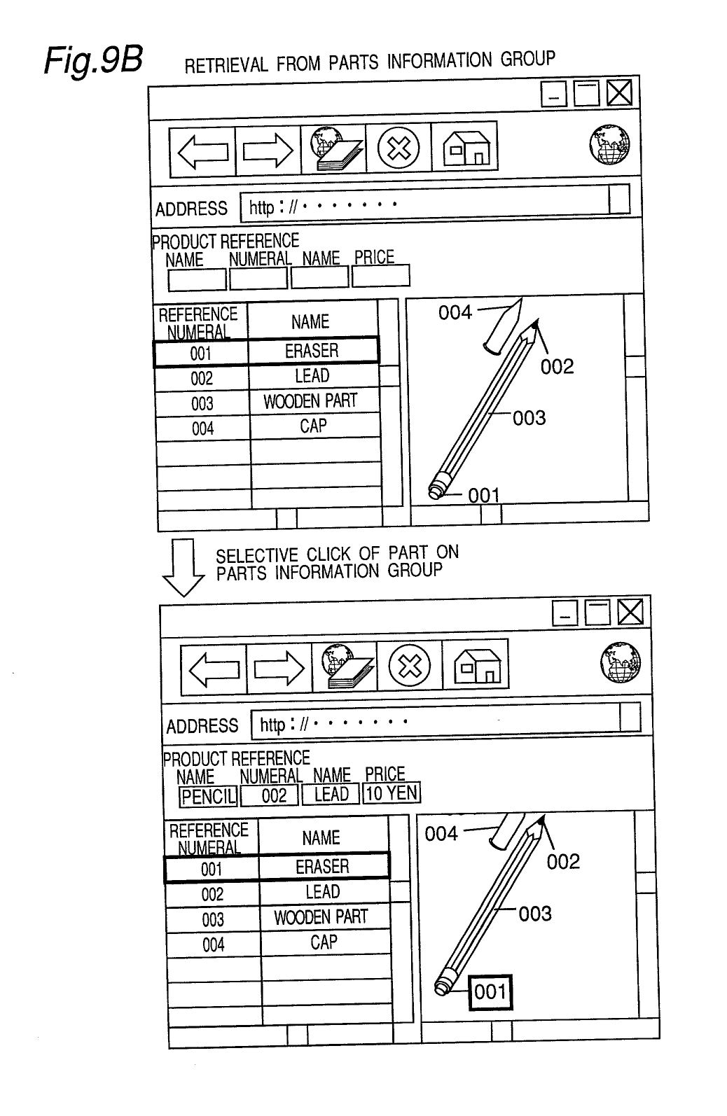

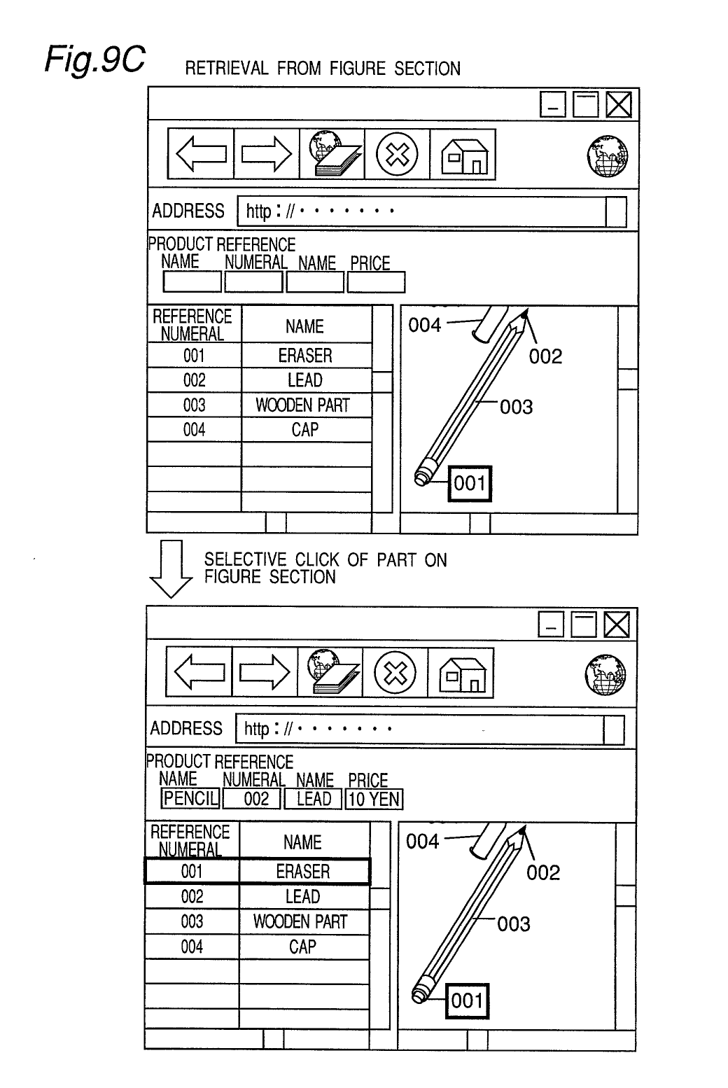

Next, referring to FIGS. 4 through 9 (FIG. 9 consists of FIGS. 9A, 9B and 9C), a description is made below upon a series of processing steps (or procedures) starting with a step at which the information provider supplies information upon retrieval objects (or objects of retrieval) and ending with a step at which the user (or retriever) finishes to retrieve a particular one of the retrieval objects by the information retrieval system.

FIG. 4 shows a display screen displayed on the general-purpose WEB browser 60 such as Internet Explorer or Netscape Navigator, at time of retrieving “an eraser” of a “pencil” as a retrieval object. The WEB browser 60 has the display screen on which a menu display section 61 which is generally arranged on an upper part of the display, a parts information display section 62 which is generally arranged on a lower left half of the display, a figure display section 64 which is generally arranged on a lower right half of the display, and a retrieval result display section 66 which is arranged between the menu display section 61 and the parts information display section 62 and between the menu display section 61 and the figure display section 64, are shown respectively.

More specifically, the menu display section 61 is used for selecting any one of various commands to the computer. The parts information display section 62 is used for displaying any detailed pieces of information upon components (or parts), including any particular retrieval object such as the “eraser” constituting the “pencil”, as a parts information list (or as a parts information group). The figure display section 64 is used for displaying a whole figure, such as the “pencil”, of all the retrieval objects including a partial figure of the particular retrieval object such as the “eraser” of the “pencil”, in which each object (or component or part), such as the “eraser”, a wooden part or a cap, constituting the “pencil”, is given a component number (or a part number) such as “001”, “002” “003” or “004”. The retrieval result display section 66 is used for displaying any detailed pieces of information (for example, a name of a whole (for instance, a name of a product) composed of the objects, a reference numeral, a name of a component (or a name of a part), a price etc.) upon the retrieval objects such as the eraser “001”, after the retrieval operation has been completed.

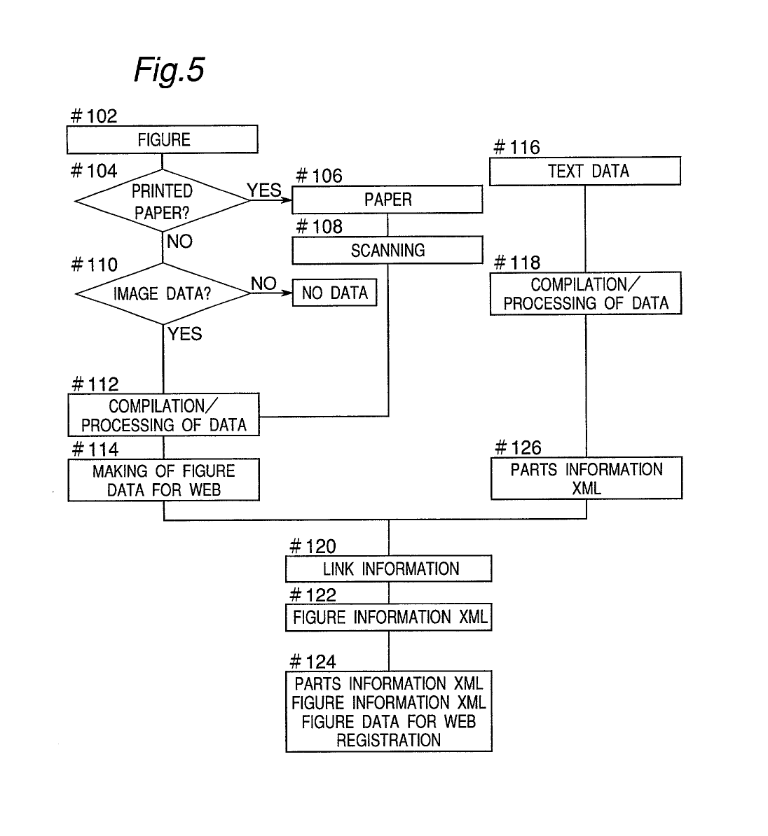

Referring to FIG. 5 which is a flowchart showing a procedure, or steps, for making electronic data with respect to the retrieval objects in the information retrieval system shown in FIG. 3, it is explained below about a method for making the electronic data.

That is, at step #102, any pieces of information in various forms upon the retrieval objects are provided, or supplied, by the information provider.

If it is determined at steps #104 and #106 that the figure information 12 and the parts information 14 provided by the information provider are not in a form of the electronic information, but in a form of printed paper material(s), then the information on the printed paper material(s) is read by a scanner, or the like, at step #108, and then the corresponding electronic information read by the scanner is processed and compiled into an XML file or electronic image data, such as a GIF file or a JPEG file, which is usable on the Internet, at step #112.

Meanwhile, if it is determined at steps #104 and #110 that the information provided by the information provider is in the form of the electronic image data such as the GIF file or the JPEG file, the information can be directly employed on the Internet without processing it. However, if they are the electronic image data corresponding to a DXF file or a PICT file which can not be employed directly on the WEB browser, they are processed and compiled to the electronic image data, such as the GIF file or the JPEG file, which are usable on the Internet, at step #112.

Thus, at step #114, figure data for WEB which are registered on the WEB server 30 and which can be employed on the Internet 40 are made. With the arrangement, the image data can be transmitted and received on the Internet 40 in a short time (i.e. promptly).

Meanwhile, if the parts information 14 supplied from the information provider is in a form of electronic data recorded in accordance with an individual, or original, format (#116), the electronic data are processed and compiled into a text data at step #118. Then, the text data thus processed and compiled are furthermore processed into the parts information XML file 36 (refer to FIG. 3) described in the XML format, at step #126.

Then, coordinate data upon parts (or components) with respect to the figure data 22 for WEB, are extracted by an automatic reading software or by a manual reading. Then, the figure information XML file 34 is made by the XML, in which the figure information XML file 34 links the coordinate data of the figure data 38 for WEB with the parts information included in the parts information XML file 36 mutually, at steps #120 and #122.

Then, at step #124, the electronic data of the figure information XML file 34, the electronic data of the parts information XML file 36, and the electronic data of the figure data 38 for WEB, are stored, or registered, on the hard disk 33 in the WEB server 30.

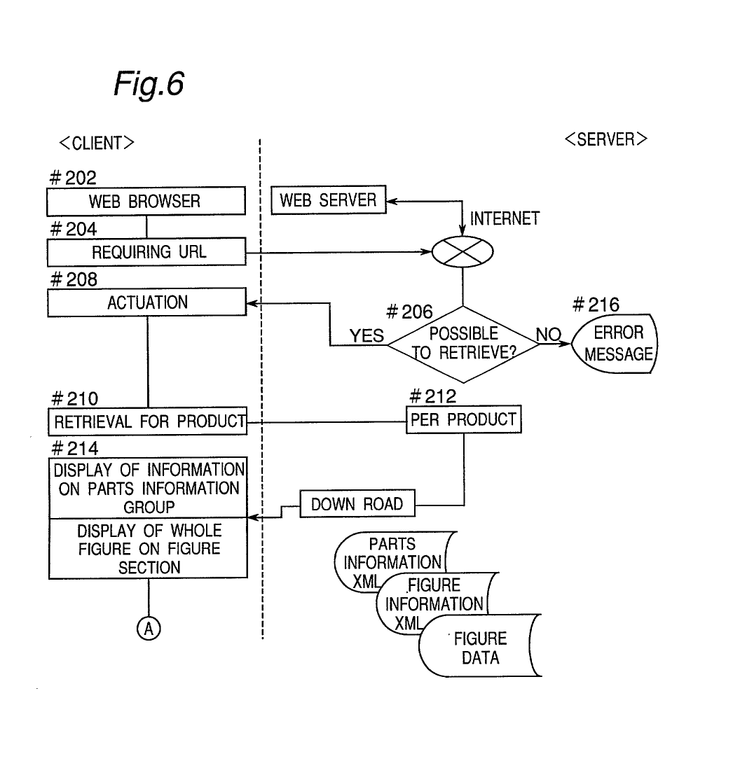

Next, referring to FIGS. 6 through 9 (FIG. 9 includes FIGS. 9A, 9B and 9C), it is explained below about a method of how the retriever retrieves any detailed pieces of information upon the retrieval objects, by making use of the information retrieval system according to the preferred embodiment.

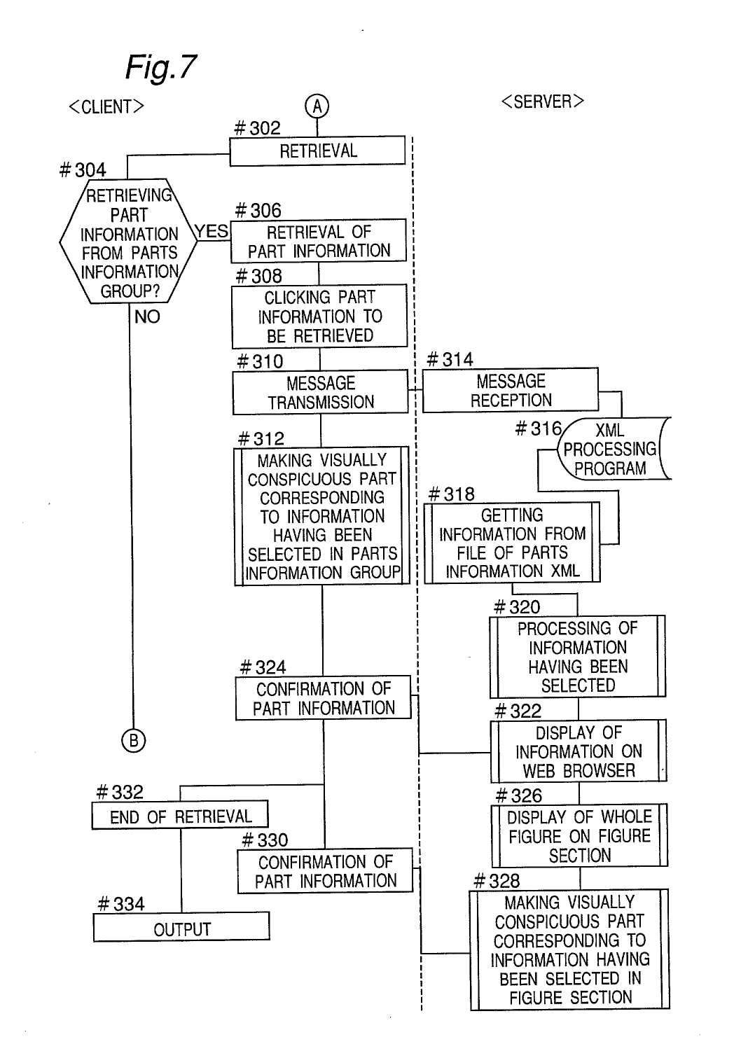

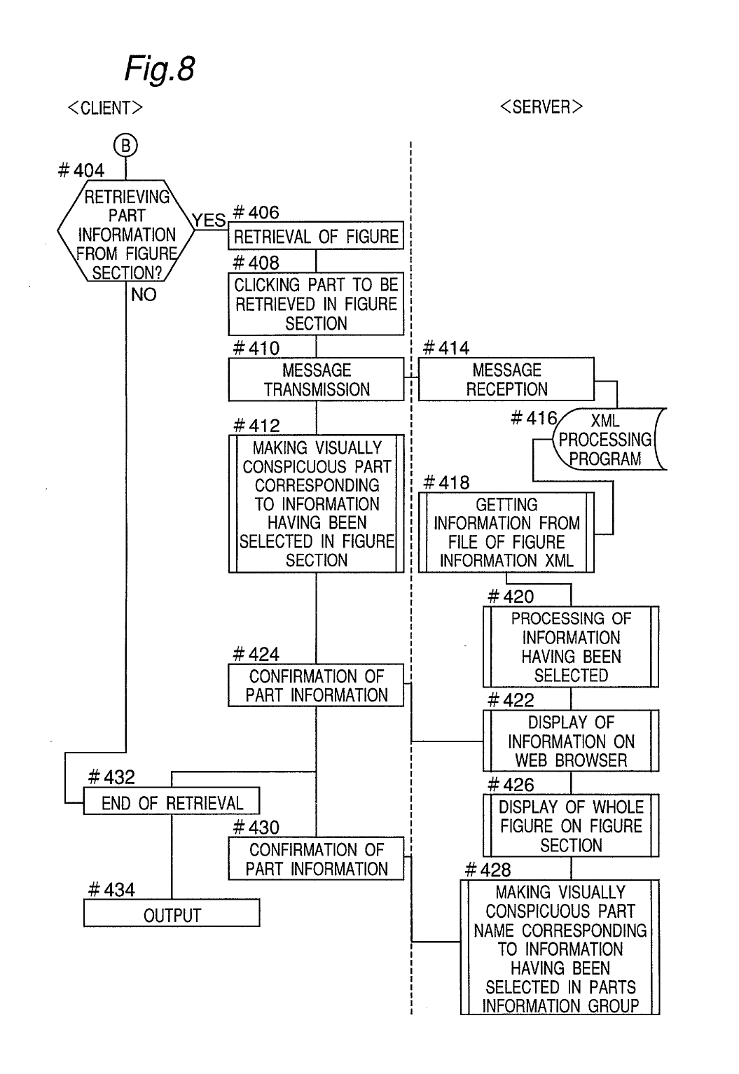

Namely, FIG. 6 is a flow chart showing a procedure, or a series of steps, executed up to a step for displaying the information on the retrieval object(s) on the WEB browser 60 in the information retrieval system of FIG. 3; FIG. 7 is a flow chart showing a procedure, or a series of steps, for retrieving the retrieval object(s), executed successively after the procedure, or the series of steps, shown in FIG. 6; FIG. 8 is a flow chart showing a procedure, or a series of steps, for retrieving the retrieval object(s), executed successively after the procedure, or the series of steps, shown in FIG. 7; and FIG. 9 (FIGS. 9A, 9B and 9C) is an explanatory view to show an operational procedure on the WEB browser 60 at time of performing the retrieval operation shown in FIGS. 7 and 8. By the way, FIG. 9B shows the procedure for retrieving the object(s) from the parts information display section 62 (refer to FIG. 4) shown on the WEB browser; and FIG. 9C shows the procedure for retrieving the object(s) from the figure display section 64 (refer to FIG. 4) shown thereon.

As shown in FIGS. 3 and 6, at step #202, the retriever actuates the client 52 (or 54 or 56) connected to the Internet 40 via the provider 44 in order to display a main menu on the screen. Upon actuation of the general-purpose WEB browser 60 such as Internet Explorer or Netscape Navigator at the same step, an enter of a predetermined address (URL) of the WEB server 30 to carry out the retrieving operation is requested at step #204.

When the retriever enters, or inputs, the predetermined address, the client 52 (or 54 or 56) is accessed to the WEB server 30 which is connected to the Internet 40 via the provider 42, and it is determined at step #206 whether it is possible to execute a retrieval operation at the moment, or not.

If it is determined at step #206 that it is not possible to execute the retrieval operation, then the message that the execution of the retrieval operation is not possible is transmitted to the client 52 (or 54 or 56), at step #216.

On the other hand, if it is determined at step #206 that it is possible to execute the retrieval operation, then a processing program for birectional retrieval (or two-way retrieval) is transmitted to the client 52 (or 54 or 56). Then, the client 52 (or 54 or 56) processes the processing program to actuate an bidirectional retrieval software (or two-way retrieval software) at step #208, and the bidirectional retrieval software is displayed on the browser 60.

Then, the retriever selects an item of “retrieval” out of various items including the “retrieval”, “save”, “print” etc. all shown on the main menu in the bidirectional retrieval software.

Then, the retriever selects an item of “retrieval per whole” out of various items including the “retrieval per whole”, “retrieval per component (or part)” and “retrieval per figure” at step #210, and then he/she selects a name (for example, a “pencil”) of “a whole” from the “retrieval per whole” at step #212.

When the information upon the name which has been selected at step #212 is transmitted to the WEB server 30, the WEB server 30 transmits the corresponding figure information XML file 34, the corresponding parts information XML file 36, and the corresponding figure data 38 for WEB, selected from the data registered, or stored, on the hard disk 33, back to the client 52 (or 54 or 56). As a result, as shown in FIG. 9A, all the pieces of information upon all the parts (or all the components) constituting the “whole” including the retrieval object(s) are displayed on the parts information display section 62 on the browser 60 of the client 52 (or 54 or 56); and the whole figure constituting the “whole” including the retrieval object(s) is displayed on the figure display section 64 thereon (#214).

Then, as shown in FIG. 7, the retriever retrieves a target retrieval object (for example, an “eraser” of the “pencil”) designated on the parts information display section 62 and on the figure display section 64 of the WEB browser 60, at step #302.

Then, at step #304, the retriever decides whether or not he/she retrieves any one out of a group of pieces of information upon parts (or upon components) which are displayed on the parts information display section 62. If the retriever decides the retrieval out of the group of pieces of information upon parts (or components) at step #306, then the retriever clicks on a target part, or location, corresponding to a desired piece of information upon the part (component) he/she wants to retrieve, out of the group of pieces of information upon various parts (or components) forming the whole (i.e. the “pencil” in the embodiment), at step #308 (also, refer to FIG. 9B). This desired piece of information upon the part (component) he/she has selected for the retrieval is transmitted, as a message, to the server at step #310, and the target part, or location, corresponding to the desired piece of information thereupon blinks and/or changes its color, at step #312, to facilitate visual identification.

The message transmitted from the client 52 (or 54 or 56) is received by the WEB server 30 at step #314. Based on the message, the XML processing program 39 is executed at step #316, and then information upon the part (or component) thus having been selected, is gained from the parts information XML file 36, at step #318.

Then, the information upon the part (or component) thus having been selected, is processed at step #320, then the information is displayed on the WEB browser 60 of the client 52 (or 54 or 56) at step #322, and then the retriever confirms the information thereupon thus having been selected, on the retrieval result display section 66 (refer to FIG. 4), at step #324.

Then, in order to realize a better visual identification on the WEB browser 60 of the client 52 (or 54 or 56), a whole figure (of the “pencil”) is made to be displayed on the figure display section 64 at step #326, and then the part, or component, corresponding to the piece of information having been selected is made to blink and/or change its color on the figure display section 64 at step #328. Then, the retriever confirms the result of the retrieval at step #330.

After confirming the parts information thereupon, the retriever finishes the retrieval operation at #332. Then, he/she saves the parts information thus having been retrieved, on a hard disk of the client 52 (or 54 or 56) and/or on a floppy disk (or floppy diskette) in use for the client 52 (or 54 or 56), and/or he/she makes a printer, connected to the client 52 (or 54 or 56), print out the parts information thereupon, at step #334. Namely, to save the parts information thereupon on the hard disk and/or on the floppy disk, and/or to print out the parts information thereupon in a form of paper material(s), allow(s) him/her to retrieve the same information thereupon with an offline state, by accessing to the information saved on the hard disk and/or on the floppy disk, and/or by visually reading the information printed on the paper material(s), which makes it possible to save, or reduce, the communication cost via the Internet.

Meanwhile, if the retriever does not decide the retrieval out of the group of pieces of information upon parts (or components) at step #304 (refer to FIG. 7), then the retriever decides whether or not he/she retrieves the parts information thereupon from the figure display section 64, at step #404 (refer to FIG. 8).

If the retriever decides the retrieval from the figure display section 64 at step #406 (refer to FIG. 4), the retriever clicks on a target part, or location, corresponding to a desired part, or component, he/she wants to retrieve, on the figure display section 64 which designates the whole figure including the retrieval object, at step #408 (refer to FIG. 9C). The information upon the target part or location (namely, the desired part or component) he/she wants to retrieve, is transmitted, as a message, to the server at step #410, and the target part, or location, on the figure display section 64, blinks and/or changes its color, at step #412, to facilitate visual identification.

The message transmitted from the client 52 (or 54 or 56) is received by the WEB server 30 at step #414. Based on the message, the XML processing program 39 is executed at step #416, and then information upon the part (or component) thus having been selected, is gained from the parts information XML file 36, at step #418.

Then, the information upon the part (or component) thus having been selected, is processed at step #420, then the information is displayed on the WEB browser 60 of the client 52 (or 54 or 56) at step #422, and then the retriever confirms the information thereupon thus having been selected, on the retrieval result display section 66 (refer to FIG. 4), at step #424.

Then, in order to realize a better visual identification on the WEB browser 60 of the client 52 (or 54 or 56), the whole figure (of the “pencil”) is made to be displayed on the figure display section 64 at step #426, and then the corresponding part, or component, on the parts information display section 62, is made to blink and/or change its color at step #428. Then the retriever confirms the result of the retrieval at step #430.

After confirming the parts information thereupon, the retriever finishes the retrieval operation at #432. Then, he/she saves the parts information thus having been retrieved, on the hard disk of the client 52 (or 54 or 56) and/or on the floppy disk (or floppy diskette) in use for the client 52 (or 54 or 56), and/or he/she makes the printer, connected to the client 52 (or 54 or 56), print out the parts information thereupon, at step #434. Namely, to save the parts information thereupon on the hard disk and/or on the floppy disk, and/or to print out the parts information thereupon in the form of paper material(s), allow(s) him/her to retrieve the same information thereupon with an offline state, by accessing to the information saved on the hard disk and/or on the floppy disk, and/or by visually reading the information printed on the paper material(s), which makes it possible to save, or reduce, the communication cost via the Internet.

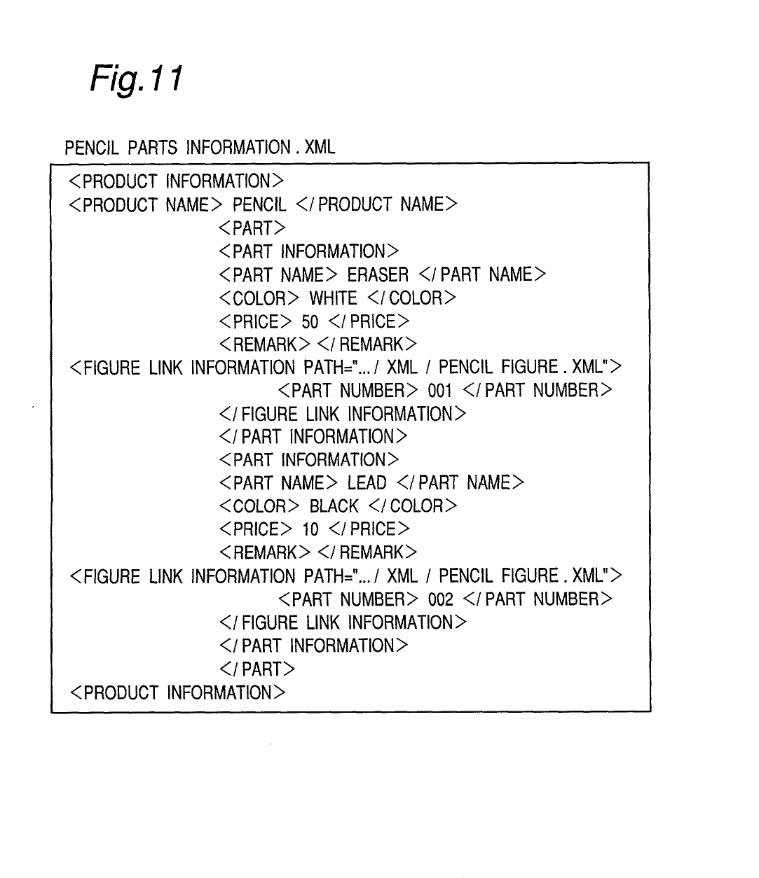

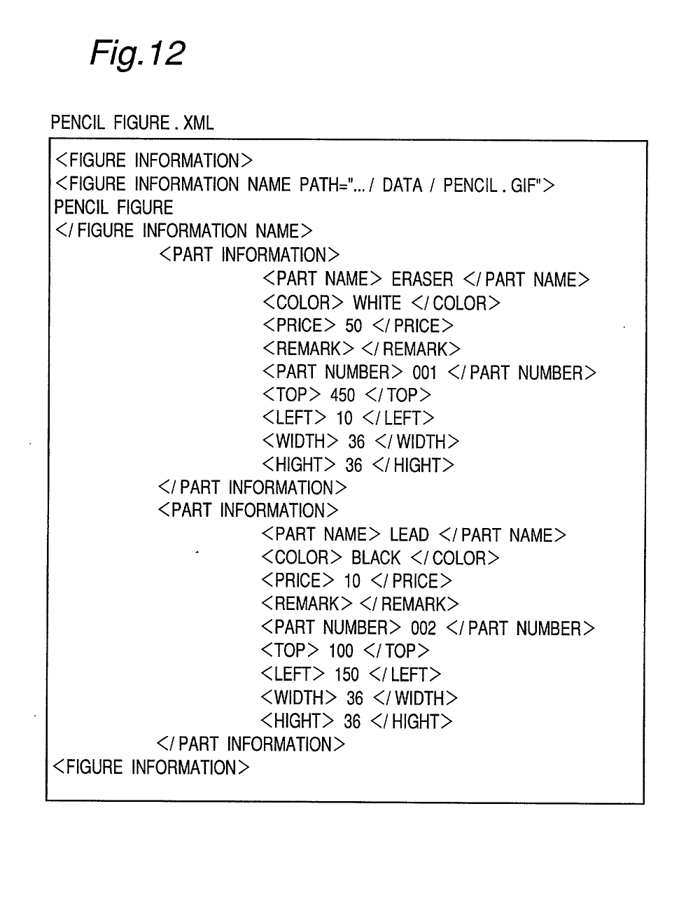

By the way, FIG. 10 is an explanatory view showing the XML file in which the parts information display section 62 displayed on the WEB browser shown in FIG. 4 and the figure display section 64 displayed thereon are linked to each other bidirectionally; FIG. 11 is an explanatory view showing detailed information included in the parts information display section 62 shown in FIG. 10; and FIG. 12 is an explanatory view showing detailed information included in the figure display section 64 shown in FIG. 10.

In the preferred embodiment, it has been explained about the target retrieval object being “an eraser” of “a pencil”. Therein, the “whole” corresponds to the “pencil”, and the target retrieval object corresponds to the “eraser” which is one “part”, or one “component”, of a plurality of parts, or components, of which the “whole” of the “pencil” is composed. It, however, goes without saying that the “whole” is not limited to the “pencil”, and that the target retrieval object is not limited to the “eraser”.

For example, as a modification to the preferred embodiment, the “whole” may be an “electric appliance”, and the target retrieval object may be a “screw” which is one “part”, or one “component”, of a plurality of parts, or components, of which the “whole” of the “electric appliance” is composed.

As another modification to the preferred embodiment, the information retrieval system may apply to information upon stores such as restaurants, book stores and the like, and upon institutes and facilities such as schools, hospitals and the like, and to a map, or atlas, on which those stores, institutes and facilities are designated, in which the information thereupon and the map (or atlas) are linked to each other. In this modification, the “whole” corresponds to the “map (or atlas)”, and the target retrieval object corresponds to any one of the “stores”, “institutes” and “facilities”.

Meanwhile, in the preferred embodiment, the parts information display section 62 and the figure display section 64 are displayed on the single WEB browser. As a modification to the preferred embodiment, it is possible to provide a pair of separate WEB browsers, one of which displays only the parts information display section, and the other of which displays only the figure display section.

Although the present invention has been fully described in connection with the preferred embodiment thereof with reference to the accompanying drawings, it is to be noted that various other changes and modifications are also apparent to those skilled in the art. Such changes and modifications are to be understood as included within the scope of the present invention as defined by the appended claims unless they depart therefrom.

What is claimed is:

1. An information retrieval system on internet, the information retrieval system including a web server and a client which is connected to the web server via the internet, in which the web server and the client have a two-way communication with each other,
the web server comprising:
figure data storage means for storing figure data on a whole including an object of retrieval and for transmitting the figure data to the client in response to an instruction from the client;
parts information storage means for storing parts information upon objects constituting the whole in which each of the objects is the object of retrieval and in which the parts information is written in mark-up language that is able to define an optional tag, and for transmitting the parts information to the client in response to an instruction from the client;
figure information storage means for storing figure information including coordinate data with respect to the figure data in which the figure information is written in mark-up language that is able to define an optional tag, and for transmitting the figure information to the client in response to an instruction from the client; and
information link means for linking the parts information and the figure information to each other bidirectionally, and
the client comprising:
a general-purpose web browser for showing the parts information and the figure data simultaneously, in which the parts information and the figure data are linked to each other bidirectionally.

2. The information retrieval system on internet as claimed in claim 1, wherein the mark-up language is Extensible Mark-up Language.

3. The information retrieval system on internet as claimed in claim 1, wherein the figure data are image data which do not have attribute of coordinates.

4. The information retrieval system on internet as claimed in claim 1, wherein when a retriever selects one of the objects of retrieval which are shown on the general-purpose web browser, the one changes visually on the general-purpose web browser.

5. The information retrieval system on internet as claimed in claim 1, which further comprises external output means for allowing a retriever to take out a result of the retrieval and to make use of the result.
